(19) United States
(12) Patent Application Publication
(10) Pub. No.: US 2007/0198318 A1
(43) Pub. Date: Aug. 23, 2007

(54) Repair relevant information providing system

(75) Inventor: Satoru Ikeya, Saitama-ken (JP)

Correspondence Address: TAIYO CORPORATION, 401 HOLLAND LANE, #407, ALEXANDRIA, VA, 22314, US

(73) Assignee: FUJIFILM CORPORATION

(21) Appl. No.: 11/657,620

(22) Filed: Jan. 25, 2007

(30) Foreign Application Priority Data
Jan. 31, 2006 (JP) 2006-023206

(51) Int. Cl. G05B 19/418; G06F 9/46

(52) U.S. Cl. 705/8; 705/35

(57) ABSTRACT

The present invention provides an information processing apparatus. In the apparatus, the shortest repair days information is determined by comparing days presented by the first transportation days information with a sum of days presented by the second transportation days information and the third transportation days information so as to acquire the shorter days, and calculating a sum of the shorter days and days presented by the repair days information. The lowest repair charge information is determined by comparing a charge presented by the first transportation charge information with a sum of charges presented by the second transportation charge information and the third transportation charge information so as to acquire the lower charge, and calculating a sum of the lower charge and a charge presented by the repair charge information.

### CROSS-REFERENCE TO RELATED APPLICATION

This application claims priority under 35USC119 from Japanese Patent Application No. 2006-023206, disclosure of which is incorporated by reference herein.

### BACKGROUND OF THE INVENTION

1. Field of the Invention

The present invention relates to an information processing apparatus, a repair relevant information providing method and a storage medium for storing a repair relevant information providing program, which provide information relating to repair of devices.

2. Description of the Related Art

According to diffusion of Internet in recent years, a lot of services using the Internet are provided. One of them is a camera failure diagnosis system disclosed in Japanese Patent Application Laid-Open (JP-A) No. 2003-9188.

This camera malfunction diagnosis system has a user terminal which is used by a user and a server computer which can be connected to the user terminal. The user terminal has a transmission component which transmits image data photographed by a camera, and the server computer has a reception component which receives the image data transmitted from the user terminal and a diagnosis component which diagnoses whether the camera which photographed the image data has a malfunction based on the image data received by the reception component.

The failure of the camera can be sensed by a user relatively easily by means of a self diagnosis function of the camera. This is applied also to the other devices such as personal computers. When a device has a malfunction and a user recognizes its failure, the user's attention is paid to how long the failure is repaired or how much the repair charge is.

A lot of users pay attention to the repair charge. Users who use devices every day concern for the repair days very much. The users who frequently use devices possibly consider that if the priority is given to the repair days rather than the repair charge, the shorter repair days is put above the slightly low repair charge.

However, conventionally there is no service which provides repair days in the case where priority is given to the repair days required for a repair of a failed device and provides a repair charge in the case where priority is given to the repair charge.

### SUMMARY OF THE INVENTION

In consideration for the above problem, it is an object of the present invention to provide an information processing apparatus, a repair relevant information providing method and a storage medium for storing a repair relevant information providing program therein, which provides repair days in the case where priority is given to the repair days required for a repair of a failed device and a repair charge in the case where priority is given to the repair charge.

In order to achieve the above object, a first aspect of the present invention includes: a component which acquires failure identification information representing failure contents of a device to be repaired; a component which acquires regional information representing a region where the device is located; a component which acquires optimum hub information representing a service hub suitable for the repair from the failure identification information; a component which acquires jurisdiction hub information representing the service hub which exercises jurisdiction over the region presented by the regional information; a component which acquires first transportation days information and first transportation charge information required for transportation of the device from the region presented by the regional information to the service hub presented by the optimum hub information from the regional information and the optimum hub information; a component which acquires second transportation days information and second transportation charge information required for transportation of the device from the service hub presented by the optimum hub information to the service hub presented by the jurisdiction hub information from the optimum hub information and the jurisdiction hub information; a component which acquires third transportation days information and third transportation charge information required for transportation from the region presented by the regional information to the service hub presented by the jurisdiction hub information from the regional information and the jurisdiction hub information; a component which acquires repair days information and repair charge information required for the repair of the device from the failure identification information; a component which compares days presented by the first transportation days information with a sum of days presented by the second transportation days information and the third transportation days information so as to acquire the shorter days, and determines a sum of the shorter days and days presented by the repair days information as shortest repair days information; and a component which compares a charge presented by the first transportation charge information with a sum of charges presented by the second transportation charge information and the third transportation charge information so as to acquire the lower charge, and determines a sum of the lower charge and a charge presented by the repair charge information as lowest repair charge information.

A second aspect of the present invention includes: acquiring failure identification information representing failure contents of a device to be repaired; acquiring regional information representing a region where the device is located; acquiring optimum hub information representing a service hub suitable for the repair from the failure identification information; acquiring jurisdiction hub information representing the service hub which exercises jurisdiction over the region presented by the regional information; acquiring first transportation days information and first transportation charge information required for transportation of the device from the region presented by the regional information to the service hub presented by the optimum hub information from the regional information and the optimum hub information; acquiring second transportation days information and second transportation charge information required for transportation of the device from the service hub presented by the optimum hub information to the service hub presented by the jurisdiction hub information from the optimum hub information and the jurisdiction hub information; acquiring third transportation days information and third transportation charge information required for transportation from the region presented by the regional information to the service hub presented by the jurisdiction hub information from the regional information and the jurisdiction hub information; acquiring repair days information and repair charge information required for the repair of the device from the failure identification information; comparing days presented by the first transportation days information with a sum of days presented by the second transportation days information and the third transportation days information so as to acquire the shorter days, and determining a sum of the shorter days and days presented by the repair days information as shortest repair days information; and comparing a charge presented by the first transportation charge information with a sum of charges presented by the second transportation charge information and the third transportation charge information so as to acquire the lower charge, and determining a sum of the lower charge and a charge presented by the repair charge information as lowest repair charge information.

A third aspect of the present invention is a storage medium which stores a repair relevant information providing program for allowing a computer to execute a process including: acquiring failure identification information representing failure contents of a device to be repaired; acquiring regional information representing a region where the device is located; acquiring optimum hub information representing a service hub suitable for the repair from the failure identification information; acquiring jurisdiction hub information representing the service hub which exercises jurisdiction over a region presented by the regional information; acquiring first transportation days information and first transportation charge information required for transportation of the device from the region presented by the regional information to the service hub presented by the optimum hub information from the regional information and the optimum hub information; acquiring second transportation days information and second transportation charge information required for transportation of the device from the service hub presented by the optimum hub information to service hub presented by the jurisdiction hub information from the optimum hub information and the jurisdiction hub information; acquiring third transportation days information and third transportation charge information required for transportation from the region presented by the regional information to the service hub presented by the jurisdiction hub information from the regional information and the jurisdiction hub information; acquiring repair days information and repair charge information required for the repair of the device from the failure identification information; comparing days presented by the first transportation days information with a sum of days presented by the second transportation days information and the third transportation days information so as to acquire the shorter days, and determining a sum of the shorter days and days presented by the repair days information as shortest repair days information; and comparing a charge presented by the first transportation charge information with a sum of charges presented by the second transportation charge information and the third transportation charge information so as to acquire the lower charge, and determining a sum of the lower charge and a charge presented by the repair charge information as lowest repair charge information.

### BRIEF DESCRIPTION OF THE DRAWINGS

FIG. 1 is a diagram illustrating a lowest charge and shortest days providing system having an information processing apparatus according to an embodiment of the present invention.

FIG. 2 is a hardware constitutional diagram of a server.

FIG. 3 is a diagram illustrating a jurisdiction DB.

FIG. 4 is a diagram illustrating a failure relevance DB.

FIG. 5 is a diagram illustrating a transportation relevance DB.

FIG. 6 is a diagram illustrating a necessary parts DB.

FIG. 7 is a diagram illustrating a stock DB.

FIG. 8 is a diagram illustrating a user DB.

FIG. 9 is a flowchart illustrating the lowest charge and shortest days providing process.

FIG. 10 is a diagram illustrating an example of a lowest charge and shortest days providing screen.

FIGS. 11A and 11B are flowcharts illustrating charge and days calculating processes.

FIG. 12 is a flowchart illustrating a repair request registration process.

FIG. 13 is a flowchart illustrating a parts transportation notification process.

FIG. 14 is a flowchart illustrating a carry-on check process.

### DETAILED DESCRIPTION OF THE INVENTION

An embodiment of the present invention is explained in detail below with reference to the drawings.

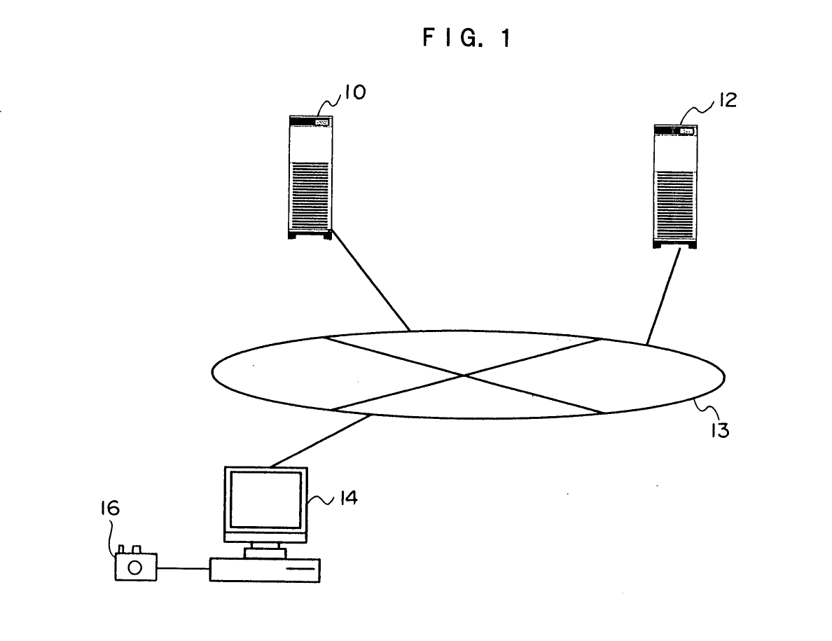

FIG. 1 is a diagram illustrating a lowest charge and shortest days providing system having an information processing apparatus according to the embodiment of the present invention. The lowest charge and shortest days providing system includes a server 10 connected to a network 13, a hub server 12, a client 14 and a camera 16.

The server 10 corresponds to the information processing apparatus, and demonstrates a repair charge in the case where priority is given to repair days required for a repair of a failed device and repair days in the case where priority is given to the repair charge to the client 14. For this reason, the server 10 has various databases (hereinafter, DB), mentioned later.

The hub server 12 is a server provided correspondingly to each service hub, and communicates with the server 10 (mentioned later). The client 14 is a personal computer of a user, and the camera 16 is a device to be repaired. The client 14 acquires a failure code representing failure contents from the camera 16, displays information from the server 10, and transmits necessary information to the server 10. The client 14 and the camera 16 send information using, for example, USB (Universal Serial Bus), IEEE1394 or Blue Tooth. The client 14 may be provided with the function of the server 10 so that the client 14 and the server 10 may be one information processing apparatus. The client (server) of this form is, for example, a personal computer installed on labs (photo finishing-stores).

The network 13 is composed of, for example, LAN, Internet or telephone line.

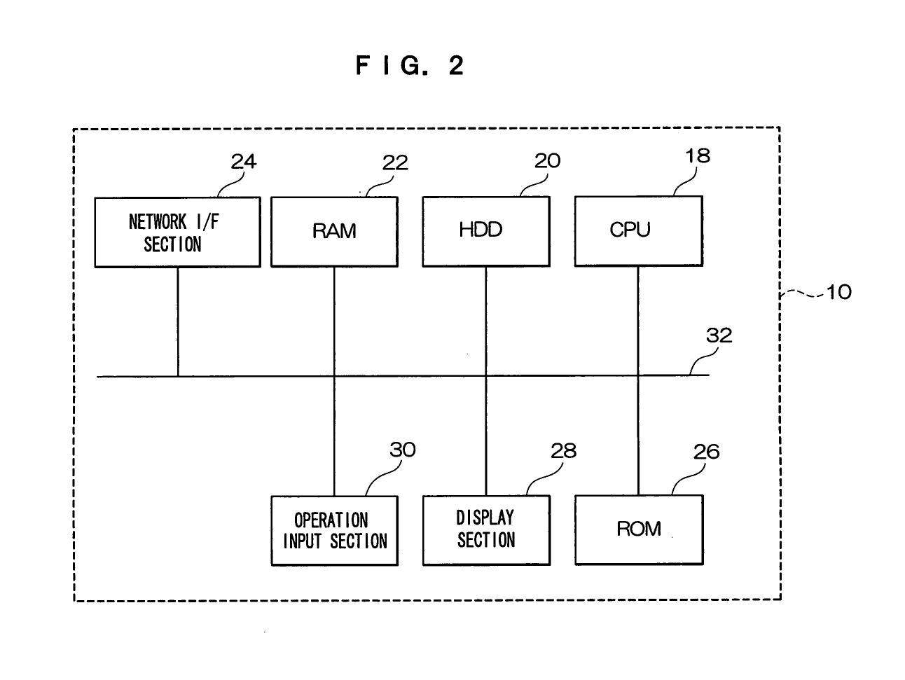

A hardware constitution of the server 10 is explained below with reference to FIG. 2. Constitutions of the hub server 12 and the client 14 are the same as the hardware constitution mentioned below.

The server 10 includes a CPU 18, an HDD 20, a RAM 22, a network I/F section 24, a ROM 26, a display section 28, an operation input section 30 and a bus 32.

The CPU 18 controls an entire operation of the server 10, and executes a flowchart showing the process of the server 10, mentioned later. The HDD 20 is a nonvolatile storage device which stores OS (operating system), a program and the like therein. The RAM 22 is a volatile storage device which stores OS, a program and the like therein. The network I/F section 24 is connected to the network 13, and is composed of NIC (Network Interface Card) and its driver. The ROM 26 is a nonvolatile storage device which stores various DBs, a boot program to be operated at the time of actuating the server 10 and the like therein. The display section 28 displays information about the server 10 to an operator. The operation input section 30 is used when the operator inputs the operations and information of the server 10. The bus 32 is used when information is sent or received.

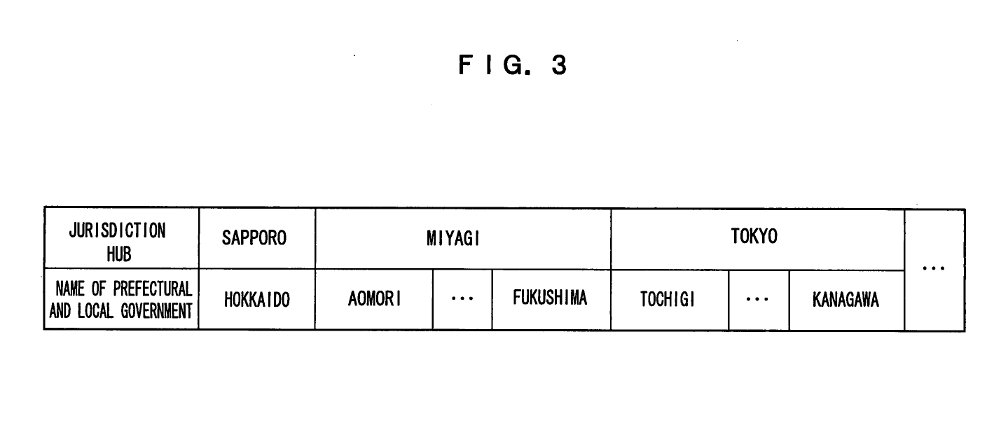

The respective DBs stored in the server 10 are explained below with reference to FIGS. 3 to 8. FIG. 3 is a diagram illustrating a jurisdiction DB. The jurisdiction DB represents hubs which exercise jurisdiction over respective prefectural and local governments. The jurisdiction DB includes jurisdiction hub information and information about prefectural and local governments over which jurisdiction is exercised by jurisdiction hubs. The jurisdiction DB is used for acquiring jurisdiction hub information corresponding to the prefectural and local government from the information about the prefectural and local government as regional information input by the user. For example, in the case of FIG. 3, when the user inputs Hokkaido (a prefecture in Japan), the jurisdiction hub of its region is Sapporo (a city in Hokkaido). The jurisdiction hub here is the nearest hub in that region or hubs determined in respective regions shown in FIG. 3.

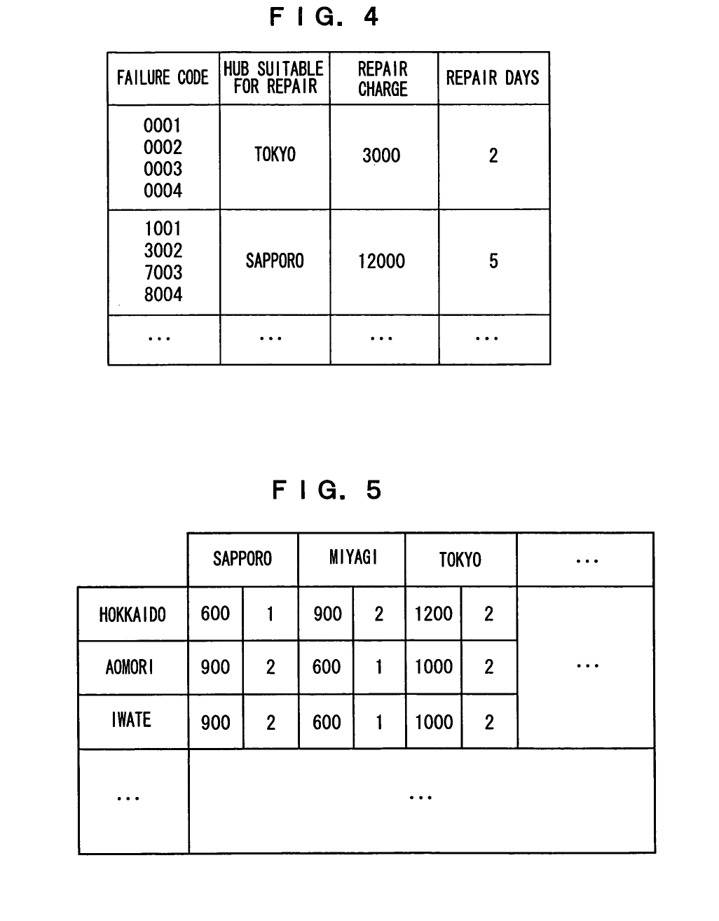

A failure relevance DB is explained below with reference to FIG. 4. The failure relevance DB includes failure code information, hub information which is suitable for repair of the failure, repair charge information for the repair of the failure, and repair days information necessary for the repair of the failure. The failure code is failure identification information representing failure contents of a device to be repaired. The failure relevance DB is used for acquiring a hub suitable for the repair of the failure, the repair charge and the repair days from the failure code acquired from the user's personal computer. For example in the case of FIG. 4, the hub which is suitable for the repair of the failure with failure code 0003 is Tokyo (a prefecture in Japan), the repair charge is 3000 Yen, and the repair days are two days.

A transportation relevance DB is explained below with reference to FIG. 5. The transportation relevance DB includes transportation charge information between a prefectural and local government and a hub, and transportation days information. All prefectural and local governments are arranged on the vertical field, and hubs are arranged on the horizontal fields. The transportation relevance DB is for acquiring the transportation charge and the transportation days required for one way transportation from a hub to a user's region or between hubs. For example in the case of FIG. 5, as to the transportation from Tokyo to Aomori (a prefecture in Japan), the transportation charge is 1000 yen and the transportation days is two days.

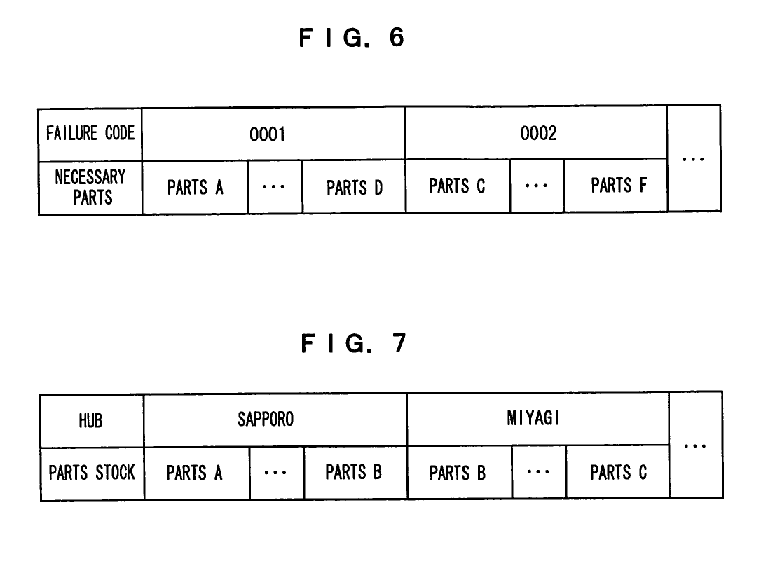

A necessary parts DB is explained below with reference to FIG. 6. The necessary parts DB includes failure code information and necessary parts information corresponding to the failure codes. The necessary parts DB is used for acquiring necessary parts for a repair from the failure codes. For example, in the case of FIG. 6, necessary parts for the repair of the failure showing failure code 0002 are parts C, F and the like.

A stock DB is explained below with reference to FIG. 7. The stock DB includes hub information and stock information about parts in the hubs. The stock DB is used for determining whether necessary stocks for repairs are present in service hubs. For example in the case of FIG. 7, in Sapporo, parts A and B are present as the stock.

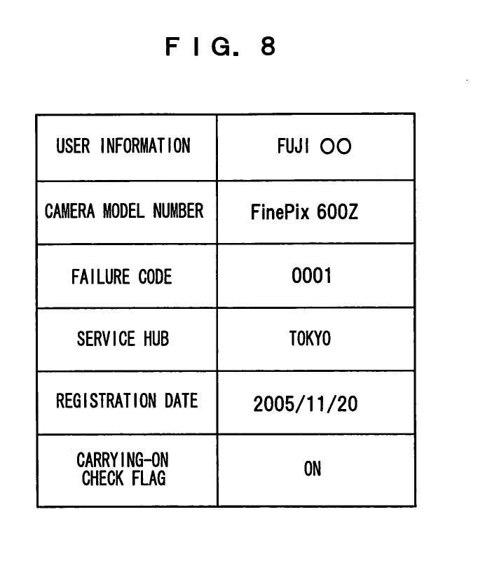

A user DB is explained below with reference to FIG. 8. The user DB includes user information, camera model number information, failure code information, service hub information, registration date information, and carrying-on check flag information.

Among these, the user information is used for identifying user, and in the case of FIG. 8, the user information is a name, however anything which identify the user may be used. The camera model number information is for identifying a camera, and in the case of FIG. 8, the camera model number information is a product name, however anything, which can identify the camera, may be used. The service hub is a service hub selected by a user. The registration date is a date at which a user requests the repair. The carrying-on check flag is a flag which is turned ON or OFF when the camera is transported to the service hub. The transportation here includes also carrying-on by the user.

The processes, which are executed by the server 10 using the above-explained DBs, are explained by using flowcharts. As a user interface of the client 14 in the process explained below, for example, a Web browser may be used. In another method, a program, which is recorded in a CD coming with the camera, is installed so as to be used as an application to be operated. Alphabets A to K used in the flowchart designate variables, and these values are stored in a stack or the like.

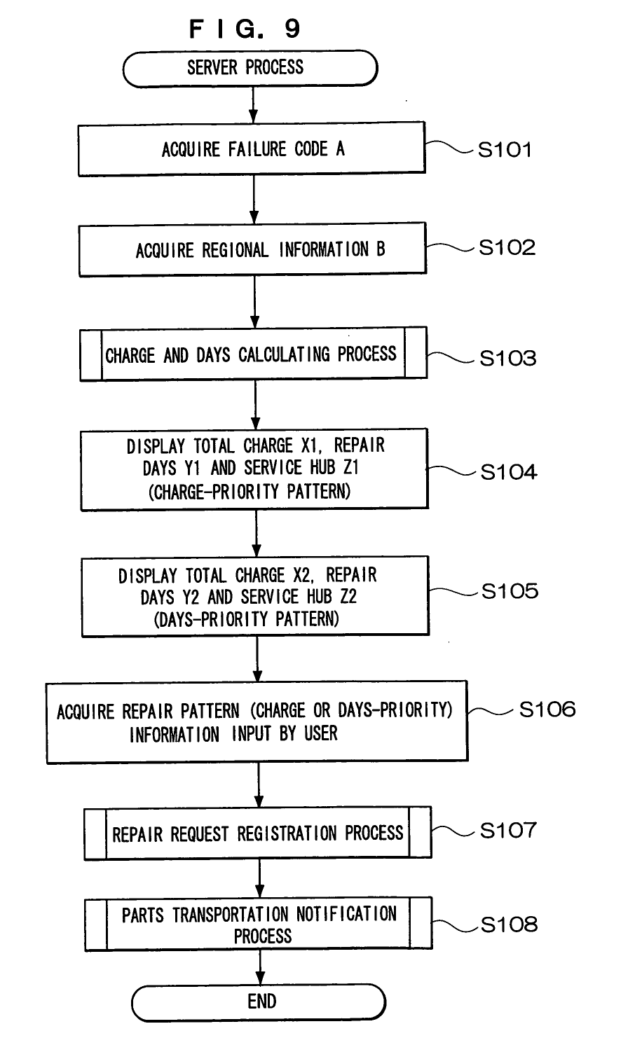

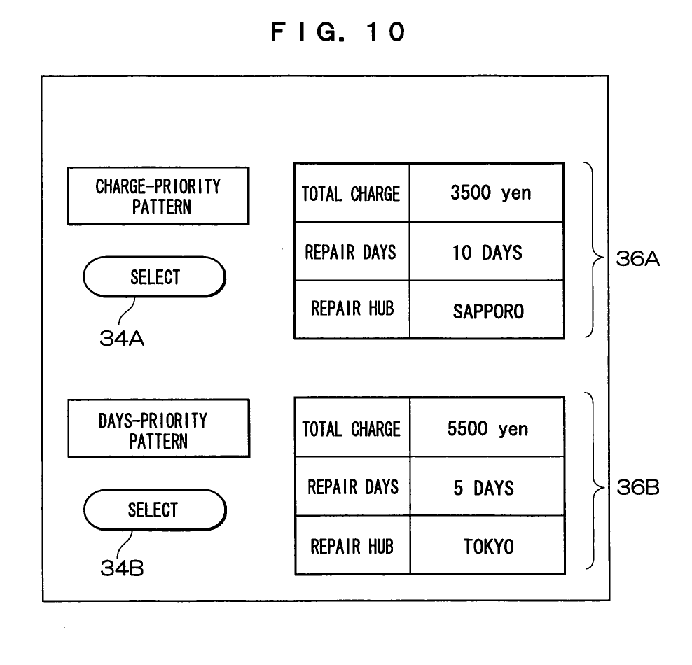

FIG. 9 is a flowchart illustrating a lowest charge and shortest days providing process of the server 10. The server 10 acquires a failure code A from the client 14 at step S101. The camera may notify the client 14 of the failure code using USB or the like as mentioned above, or the user may manually input the failure code.

The server 10 acquires regional information B from the client 14 at step S102. A charge and days calculating process is executed at step S103 by using A and B. The charge and days calculating process obtains total charges X1 and X2, repair days Y1 and Y2 and service hubs Z1 and Z2, mentioned later.

The total charge X1, the repair days Y1 and the service hub Z1 in the case of charge-priority pattern are displayed at step S104. The total charge X2, the repair days Y2 and the service hub Z22 in the case of the days-priority pattern are displayed at step S105.

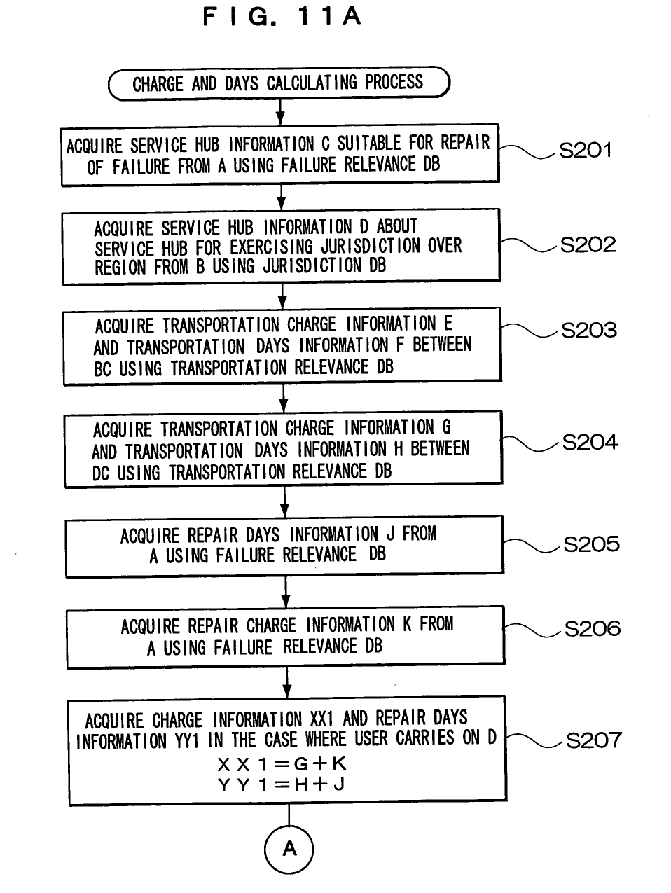

An example of the screen to be displayed on the client 14 at this time is shown in FIG. 10. FIG. 10 illustrates repair relevant information 36A in the case of the charge-priority pattern, repair relevant information 36B in the case of the days-priority pattern, buttons 34A and 34B for selecting respective patterns by the user. The total charge of the repair relevant information 36A corresponds to lowest repair charge information. The repair days of the repair relevant information 36B corresponds to the shortest repair days information.

3500 yen as the total charge of the repair relevant information 36A is lower than 5500 yen as the total charge of the repair relevant information 36B. Further, 5 days as the repair days of the repair relevant information 36B is shorter than 10 days as the repair days of the repair relevant information 36A. The server 10 demonstrates the shortest repair days information and the lowest repair charge information to the user via the client 14 in such a manner.

When the user selects any one of the patterns, the server 10 acquires pattern information at step S106 in FIG. 9. As a result, the user completes the request for the repair, and the server 10 executes the repair request registration process at step S107 and the parts transportation notification process at step S108.

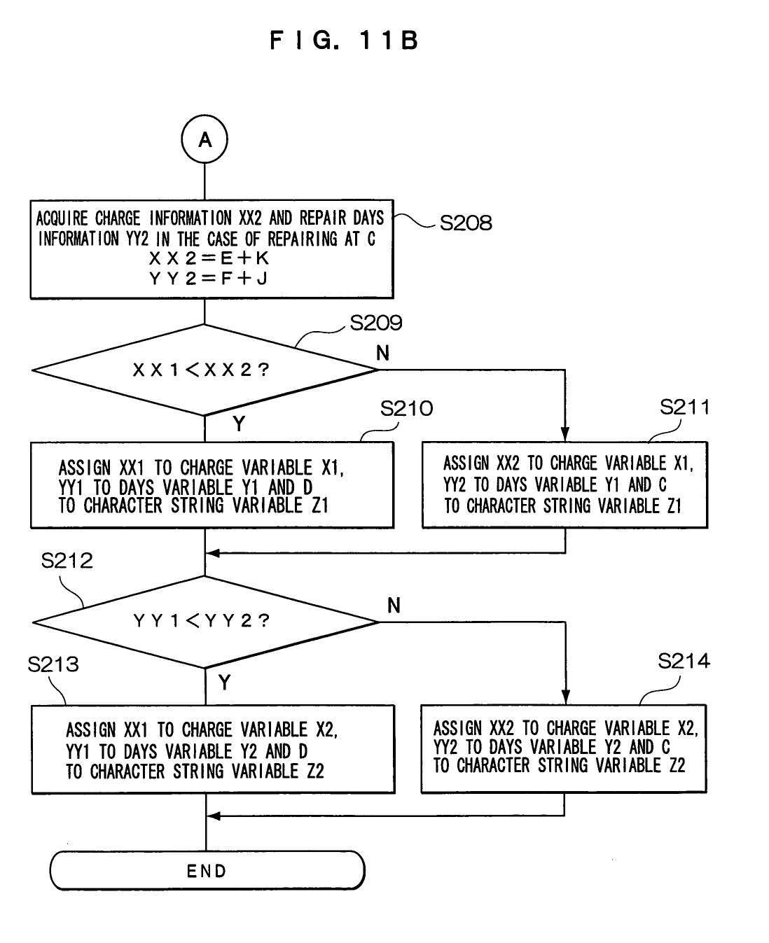

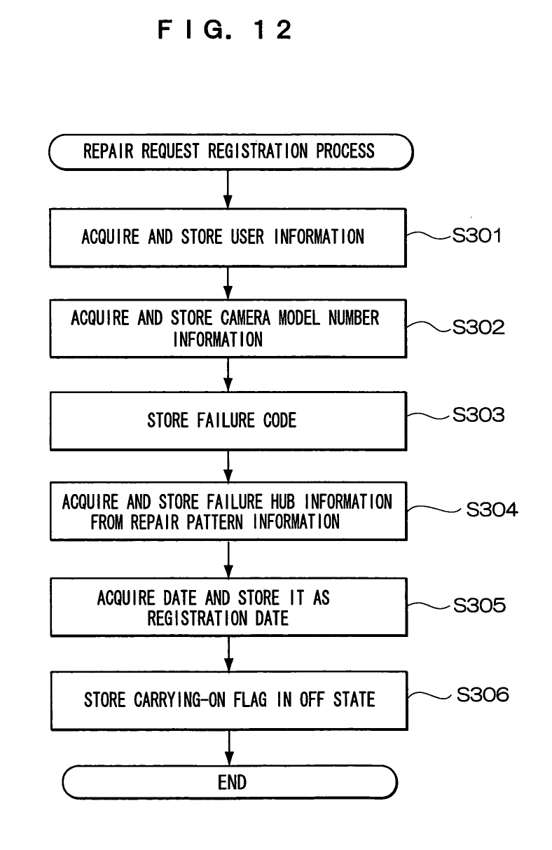

The charge and days calculating process at step S103 is explained below with reference to flowcharts in FIG. 11A and 11B. In the flowcharts, steps S201 to 206 are a process for acquiring information necessary for the calculation of the charge and days from the respective DBs, and the process thereafter is the calculating process. The flowcharts show the process not in the case where the user transports the camera to a jurisdiction hub but in the case where the user carries on the camera. The third transportation days information, therefore, shows 0 day, and information corresponding to the third transportation charge information is 0 yen.

The server 10 acquires service hub information C which is suitable for the repair of the failure from A using the failure relevance DB (see FIG. 4) at step S201. The server 10 acquires service hub information D about jurisdiction over a region from B using the jurisdiction DB (see FIG. 3) at step S202.

The server 10 acquires transportation charge information E and transportation days information F about between B and C using the transportation relevance DB (see FIG. 5) at step S203. These information relates to the transportation of a device from the hub to the user in the case where the user requests for the repair at C, and F corresponds to the first transportation days information and E corresponds to the first transportation charge information.

The server 10 acquires transportation charge information G and transportation days information H about between D and C using the transportation relevance DB at next step S204. These information relates to the transportation of parts in the case where the user carries the device on D, and H corresponds to the second transportation days information and G corresponds to the second transportation charge information.

The server 10 acquires repair days information J from A using the failure relevance DB at step S205. Further, the server 10 acquires repair charge information K from A using the failure relevance DB at step S206.

The calculating process after the following steps is executed based on the information acquired by the above process. The server 10 acquires charge information XX1 and repair days information YY1 in the case where the user carries the camera on D at step S207. The information is obtained by the equation XX1=G+K and YY1=H+J. When the user does not carry the camera on but transport it, since the charge presented by the third transportation charge information is added, the charge is obtained by the equation XX1=G+K+(double transportation charge from a user's region to D). Since the days presented by the third transportation days information is added, it is obtained by the equation YY1=H+J+(double transportation days from the user's region to D).

The server 10 acquires charge information XX2 and repair days information YY2 in the case of repair at C at step S208. They are obtained by the equation XX2=E+K and YY2=F+J. The charge and days required for the transportation of the camera to C are not included at step S208, but in the case where they are included, XX2=2×E+K and YY2=2×F+J.

According to the above process, the charge and the days for the repair pattern at the hub suitable for the repair and the pattern in the case of carrying on the hub are obtained.

The server 10 determines whether XX1<XX2 at step S209. This step is the determination as to the charge. When the determination is positive, the server 10 assigns XX1 to a charge variable X1, YY1 to a days variable Y1 and D to a character string variable Z1 at step S210. The character string variable is a variable to which the service hub information is assigned.

When the determination is negative at step S209, the server 10 assigns XX2 to the charge variable X1, YY2 to the days variable Y1 and C to the character string variable Z1 at step S211.

According to the above process, the total charge, the repair days and the service hub in the case of the charge-priority pattern are determined. A determination as to the days is made at step S212. The server 10 determines whether YY1<YY2 at step S212. When the determination is positive, the server 10 assigns XX1 to a charge variable X2, YY1 to a days variable Y2 and D to a character string variable Z2 at step S213. When the determination is negative at step S212, the server 10 assigns XX2 to the charge variable X2, YY2 to the days variable Y2 and C to the character string variable Z2 at step S214.

According to the above process, the total charge, the repair days and the service hub in the case of the repair days-priority pattern are determined, and the repair charge in the case where priority is given to the repair days required for the repair of a failed device and the repair days in the case where priority is given to the repair charge can be provided. These information are demonstrated to the user as shown in FIG. 10.

A repair request registration process (S107 in FIG. 9) is explained below with reference to a flowchart in FIG. 12. This process is for storing information into the user DBs (see FIG. 8), and the information is input by a user so as to be acquired via the client 14.

The server 10 acquires and stores user information at step S301. The server 10 acquires and stores camera model number information at step S302. The server 10 stores a failure code at step S303. The server 10 acquires and stores service hub information from repair pattern information at step S304. The server 10 acquires data and stores it as registration date at step S305. The server 10 records a carrying-on flag in an OFF state at step S306.

According to the above process, various information are stored in the user DB. The user DB in which the information is stored is used for a carrying-on check process, mentioned later.

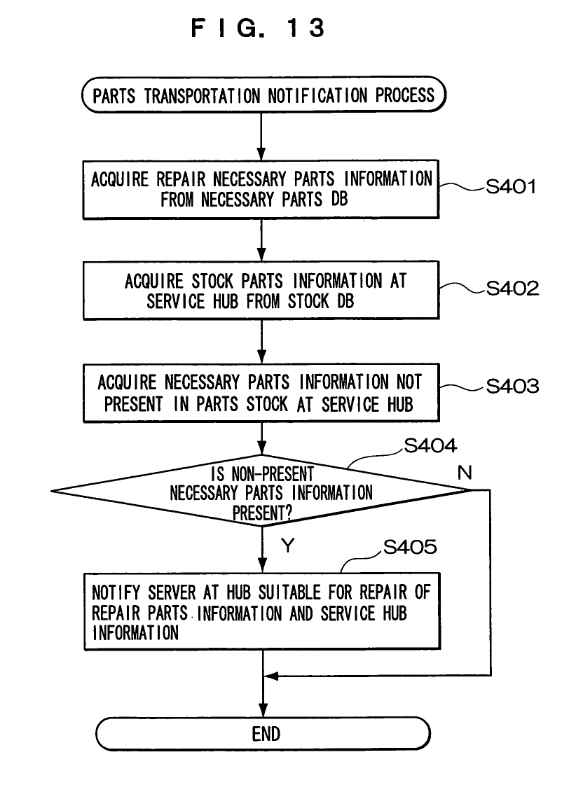

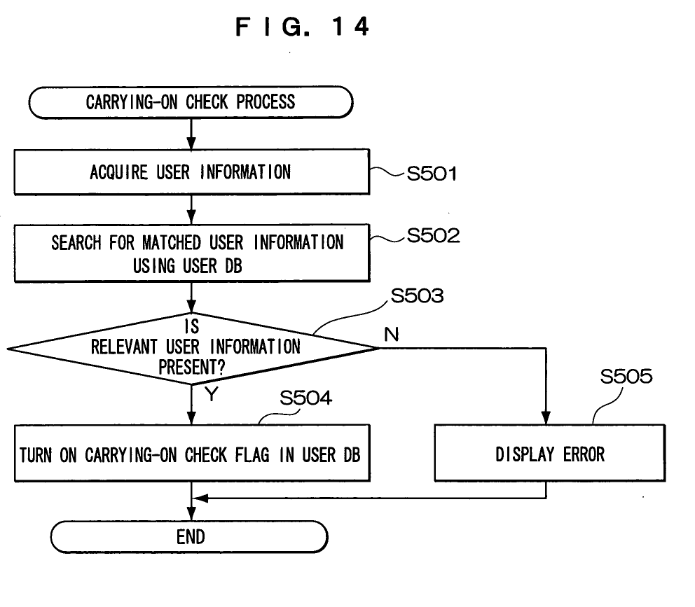

A parts transportation notification process (S108 in FIG. 9) is explained below with reference to a flowchart in FIG. 13. The server 10 acquires repair necessary parts information from the necessary parts DB (see FIG. 6) at step S401. The server 10 acquires stock parts information at the service hub from the stock DB (see FIG. 7) at step S402.

The server 10 compares the acquired repair necessary parts information and stock parts information at step S403, and acquires information about necessary parts not being present on the stock at the service hub. As a result, a determination is made at step S404 whether non-present necessary parts information is present. When the determination is negative, the process is ended, and when the determination is positive, the server at the hub suitable for the repair is notified of the repair parts information and the service hub information at step S405. The hub suitable for the repair is acquired at step S201 in FIGS. 11A and 11B.

According to this process, the parts necessary for the repair can be prepared, and thus the repair can be quickly carried out.

The carrying-on check process is explained below with reference to a flowchart in FIG. 14. The server 10 acquires user information at step S501. The user information is input by the user who carried the camera on using the hub server 12, or the name described on the transported camera is input by an operator of the hub server 12 so that the server 10 can acquire the user information.

The server 10 searches for matched user information using the user DB at next step S502, and a determination is made whether the relevant user information is present at step S503. When the determination is negative, an error is displayed at step S505. When the determination is positive, the carrying-on check flag in the user DB is turned ON.

According to this process, a check can be made whether the carried on or transported device is carried on the service hub.

In the embodiment of the present invention, the prefectural and local governments, cities and towns in Japan are used as a region, however the present invention is not limited to these. Suitable regional sections in countries can be used as a region.

As mentioned above, a first aspect of the present invention includes: a component which acquires failure identification information representing failure contents of a device to be repaired; a component which acquires regional information representing a region where the device is located; a component which acquires optimum hub information representing a service hub suitable for the repair from the failure identification information; a component which acquires jurisdiction hub information representing the service hub which exercises jurisdiction over the region presented by the regional information; a component which acquires first transportation days information and first transportation charge information required for transportation of the device from the region presented by the regional information to the service hub presented by the optimum hub information from the regional information and the optimum hub information; a component which acquires second transportation days information and second transportation charge information required for transportation of the device from the service hub presented by the optimum hub information to the service hub presented by the jurisdiction hub information from the optimum hub information and the jurisdiction hub information; a component which acquires third transportation days information and third transportation charge information required for transportation from the region presented by the regional information to the service hub presented by the jurisdiction hub information from the regional information and the jurisdiction hub information; a component which acquires repair days information and repair charge information required for the repair of the device from the failure identification information; a component which compares days presented by the first transportation days information with a sum of days presented by the second transportation days information and the third transportation days information so as to acquire the shorter days, and determines a sum of the shorter days and days presented by the repair days information as shortest repair days information; and a component which compares a charge presented by the first transportation charge information with a sum of charges presented by the second transportation charge information and the third transportation charge information so as to acquire the lower charge, and determines a sum of the lower charge and a charge presented by the repair charge information as lowest repair charge information.

In the image processing apparatus of the first aspect, the failure identification information representing the failure contents of the device to be repaired is acquired, and the regional information representing the region where the device is located is acquired. The optimum hub information representing the service hub suitable for the repair is acquired from the failure identification information, and the jurisdiction hub information representing the service hub for exercising jurisdiction over the region presented by the regional information is acquired. The first transportation days information and the first transportation charge information, which are necessary for the transportation of the device from the region presented by the regional information to the service hub presented by the optimum hub information, are acquired from the regional information and the optimum hub information. The second transportation days information and the second transportation charge information which are necessary for the transportation of the parts necessary for the repair from the service hub presented by the optimum hub information to the service hub presented by the jurisdiction hub information are acquired from the optimum hub information and the jurisdiction hub information. The third transportation days information and the third transportation charge information, which are necessary for the transportation of the device from the region presented by the regional information to the service hub presented by the jurisdiction hub information, are acquired from the regional information and the jurisdiction hub information. The repair days information and the repair charge information necessary for the repair of the device are acquired from the failure identification information. The days presented by the first transportation information is compared with the sum of the days presented by the second transportation days information and the third transportation days information so that the shorter days is obtained, and the sum of the shorter days and the days presented by the repair day information is determined as shortest repair days information. The charge presented by the first transportation charge information is compared with the sum of the charges presented by the second transportation charge information and the third transportation charge information so that the lower charge is obtained, and the sum of the lower charge and the charge presented by the repair charge information is determined as the lowest repair charge information. For this reason, the information processing apparatus, which can provide the repair charge in the case where priority is given to the repair days required for the repair of the failed device and the repair days in the case where priority is given to the repair charge, can be provided.

The invention of the first aspect may further have a component which demonstrates the shortest repair days information and the lowest repair charge information to the user.

The information processing apparatus can demonstrate the shortest repair days information and the lowest repair charge information to the user.

The invention of the first aspect may further have a component which transmits parts information representing parts necessary for the repair and service hub information about the service hub where the device is repaired to the information processing apparatus in a service hub having the parts necessary for the repair in the case where the parts necessary for the repair of the device are not present in the service hub where the device is repaired.

The information processing apparatus can prepare the parts necessary for the repair so as to be capable of quickly carrying out the repair.

The invention of the first aspect may further have a component which checks that the device is transported to the service hub.

The information processing apparatus can check whether the carried on or transported device is carried on the service hub.

A second aspect of the present invention includes: acquiring failure identification information representing failure contents of a device to be repaired; acquiring regional information representing a region where the device is located; acquiring optimum hub information representing a service hub suitable for the repair from the failure identification information; acquiring jurisdiction hub information representing the service hub which exercises repair services over the region presented by the regional information; acquiring first transportation days information and first transportation charge information required for transportation of the device from the region presented by the regional information to the service hub presented by the optimum hub information from the regional information and the optimum hub information; acquiring second transportation days information and second transportation charge information required for transportation of the device from the service hub presented by the optimum hub information to the service hub presented by the jurisdiction hub information from the optimum hub information and the jurisdiction hub information; acquiring third transportation days information and third transportation charge information required for transportation from the region presented by the regional information to the service hub presented by the jurisdiction hub information from the regional information and the jurisdiction hub information; acquiring repair days information and repair charge information required for the repair of the device from the failure identification information; comparing days presented by the first transportation days information with a sum of days presented by the second transportation days information and the third transportation days information so as to acquire the shorter days, and determining a sum of the shorter days and days presented by the repair days information as shortest repair days information; and comparing a charge presented by the first transportation charge information with a sum of charges presented by the second transportation charge information and the third transportation charge information so as to acquire the lower charge, and determining a sum of the lower charge and a charge presented by the repair charge information as lowest repair charge information.

The repair relevant information providing method from the second aspect of the present invention can produce the same effect as that of the first aspect of the present invention.

The second aspect of the present invention may further include demonstrating the shortest repair days information and the lowest repair charge information to the user.

The second aspect of the present invention may further include transmitting parts information representing parts necessary for the repair and service hub information about the service hub where the device is repaired to the information processing apparatus in a service hub having the parts necessary for the repair in the case where the parts necessary for the repair of the device are not present in the service hub where the device is repaired.

The second aspect of the present invention may includes checking that the device is transported to the service hub.

A third aspect of the present invention is a storage medium which stores a repair relevant information providing program for allowing a computer to execute a process including: acquiring failure identification information representing failure contents of a device to be repaired; acquiring regional information representing a region where the device is located; acquiring optimum hub information representing a service hub suitable for the repair from the failure identification information; acquiring jurisdiction hub information representing the service hub which exercises jurisdiction over a region presented by the regional information; acquiring first transportation days information and first transportation charge information required for transportation of the device from the region presented by the regional information to the service hub presented by the optimum hub information from the regional information and the optimum hub information; acquiring second transportation days information and second transportation charge information required for transportation of the device from the service hub presented by the optimum hub information to service hub presented by the jurisdiction hub information from the optimum hub information and the jurisdiction hub information; acquiring third transportation days information and third transportation charge information required for transportation from the region presented by the regional information to the service hub presented by the jurisdiction hub information from the regional information and the jurisdiction hub information; acquiring repair days information and repair charge information required for the repair of the device from the failure identification information; comparing days presented by the first transportation days information with a sum of days presented by the second transportation days information and the third transportation days information so as to acquire the shorter days, and determining a sum of the shorter days and days presented by the repair days information as shortest repair days information; and comparing a charge presented by the first transportation charge information with a sum of charges presented by the second transportation charge information and the third transportation charge information so as to acquire the lower charge, and determining a sum of the lower charge and a charge presented by the repair charge information as lowest repair charge information.

The storage medium which stores the repair relevant information providing program according to the third aspect of the present invention also produces the effect similar to that of the first aspect of the present invention.

The third aspect of the present invention may include demonstrating the shortest repair days information and the lowest repair charge information to the user.

The third aspect of the present invention may further include transmitting parts information representing parts necessary for the repair and service hub information about the service hub where the device is repaired to the information processing apparatus in a service hub having the parts necessary for the repair in the case where the parts necessary for the repair of the device are not present in the service hub where the device is repaired.

The third aspect of the present invention may further include checking that the device is transported to the service hub.

According to the present invention, the information processing apparatus, the repair relevant information providing method and the storage medium for storing a repair relevant information providing program which provide the repair days in the case where priority is given to the repair days necessary for the repair of a failed device and the repair charge in the case where priority is given to the repair charge can be provided.

What is claimed is:

1. An information processing apparatus comprising:
a component which acquires failure identification information representing failure contents of a device to be repaired;
a component which acquires regional information representing a region where the device is located;
a component which acquires optimum hub information representing a service hub suitable for the repair, from the failure identification information;
a component which acquires jurisdiction hub information representing the service hub which exercises jurisdiction over the region presented by the regional information;
a component which acquires first transportation days information and first transportation charge information required for transportation of the device from the region presented by the regional information to the service hub presented by the optimum hub information, from the regional information and the optimum hub information;
a component which acquires second transportation days information and second transportation charge information required for transportation of the parts necessary for the repair from the service hub presented by the optimum hub information to the service hub presented by the jurisdiction hub information, from the optimum hub information and the jurisdiction hub information;
a component which acquires third transportation days information and third transportation charge information required for transportation of the device from the region presented by the regional information to the service hub presented by the jurisdiction hub information, from the regional information and the jurisdiction hub information;
a component which acquires repair days information and repair charge information required for the repair of the device, from the failure identification information;
a component which compares the number of days presented by the first transportation days information with a sum of the number of days presented by the second transportation days information and the third transportation days information so as to acquire the shorter number of days, and determines a sum of the shorter number of days and the number of days presented by the repair days information as shortest repair days information; and
a component which compares a charge presented by the first transportation charge information with a sum of charges presented by the second transportation charge information and the third transportation charge information so as to acquire the lower charge, and determines a sum of the lower charge and a charge presented by the repair charge information as lowest repair charge information.

2. The information processing apparatus of claim 1 further comprising a component which demonstrates the shortest repair days information and the lowest repair charge information to a user.

3. The information processing apparatus of claim 1 further comprising a component which transmits parts information representing parts necessary for the repair and service hub information about the service hub where the device is to be repaired to the information processing apparatus in a service hub having the parts necessary for the repair in a case where the parts necessary for the repair of the device are not present in the service hub where the device is to be repaired.

4. The information processing apparatus of claim 1 further comprising a component which checks that the device is transported to the service hub.

5. A method of providing repair relevant information comprising:
acquiring failure identification information representing failure contents of a device to be repaired;
acquiring regional information representing a region where the device is located;
acquiring optimum hub information representing a service hub suitable for the repair, from the failure identification information;
acquiring jurisdiction hub information representing the service hub which exercises jurisdiction over the region presented by the regional information;
acquiring first transportation days information and first transportation charge information required for transportation of the device from the region presented by the regional information to the service hub presented by the optimum hub information, from the regional information and the optimum hub information;
acquiring second transportation days information and second transportation charge information required for transportation of parts necessary for the repair from the service hub presented by the optimum hub information to the service hub presented by the jurisdiction hub information, from the optimum hub information and the jurisdiction hub information;
acquiring third transportation days information and third transportation charge information required for transportation of the device from the region presented by the regional information to the service hub presented by the jurisdiction hub information, from the regional information and the jurisdiction hub information;
acquiring repair days information and repair charge information required for the repair of the device, from the failure identification information;
comparing the number of days presented by the first transportation days information with a sum of the number of days presented by the second transportation days information and the third transportation days information so as to acquire the shorter number of days, and determining a sum of the shorter number of days and the number of days presented by the repair days information as shortest repair days information; and
comparing a charge presented by the first transportation charge information with a sum of charges presented by the second transportation charge information and the third transportation charge information so as to acquire the lower charge, and determining a sum of the lower charge and a charge presented by the repair charge information as lowest repair charge information.

6. The method of claim 5 further comprising demonstrating the shortest repair days information and the lowest repair charge information to a user.

7. The method of claim 5 further comprising transmitting parts information representing parts necessary for the repair and service hub information about the service hub where the device is to be repaired to an information processing apparatus in a service hub having the parts necessary for the repair in a case where the parts necessary for the repair of the device are not present in the service hub where the device is to be repaired.

8. The method of claim 5 further comprising checking that the device is transported to the service hub.

9. A storage medium readable by a computer, the storage medium storing a program of instructions executable by the computer to perform a function for providing repair relevant information, the function comprising:
acquiring failure identification information representing failure contents of a device to be repaired;
acquiring regional information representing a region where the device is located;
acquiring optimum hub information representing a service hub suitable for the repair, from the failure identification information;
acquiring jurisdiction hub information representing the service hub which exercises jurisdiction over the region presented by the regional information;
acquiring first transportation days information and first transportation charge information required for transportation of the device from the region presented by the regional information to the service hub presented by the optimum hub information, from the regional information and the optimum hub information;
acquiring second transportation days information and second transportation charge information required for transportation of the parts necessary for the repair from the service hub presented by the optimum hub information to the service hub presented by the jurisdiction hub information, from the optimum hub information and the jurisdiction hub information;
acquiring third transportation days information and third transportation charge information required for transportation of the device from the region presented by the regional information to the service hub presented by the jurisdiction hub information, from the regional information and the jurisdiction hub information;
acquiring repair days information and repair charge information required for the repair of the device, from the failure identification information;
comparing the number of days presented by the first transportation days information with a sum of the number of days presented by the second transportation days information and the third transportation days information so as to acquire the shorter number of days, and determining a sum of the shorter number of days and the number of days presented by the repair days information as shortest repair days information; and
comparing a charge presented by the first transportation charge information with a sum of charges presented by the second transportation charge information and the third transportation charge information so as to acquire the lower charge, and determining a sum of the lower charge and a charge presented by the repair charge information as lowest repair charge information.

10. The storage medium of claim 9, wherein the function further comprises demonstrating the shortest repair days information and the lowest repair charge information to a user.

11. The storage medium of claim 9, wherein the function further comprises transmitting parts information representing parts necessary for the repair and service hub information about the service hub where the device is to be repaired to an information processing apparatus in a service hub having the parts necessary for the repair in a case where the parts necessary for the repair of the device are not present in the service hub where the device is to be repaired.

12. The storage medium of claim 9, wherein the function further comprises checking that the device is transported to the service hub.
